(19) United States
(12) Patent Application Publication
(10) Pub. No.: US 2004/0196135 A1
(43) Pub. Date: Oct. 7, 2004

(54) Electrical safety device and method for its production

(76) Inventor: Didier Clair, Regensburg (DE)

Correspondence Address: Andreas Grubert, Baker Botts L.L.P., One Shell Plaza, 910 Louisiana, Houston, TX, 77002-4995, US

(21) Appl. No.: 10/795,161

(22) Filed: Mar. 5, 2004

(30) Foreign Application Priority Data
Mar. 7, 2003 (DE) D10310159.4

(51) Int. Cl. H01H 85/02

(52) U.S. Cl. 337/198

(57) ABSTRACT

To reduce the space required in an electric circuit an electrical safety device (1) is proposed that combines the functions of a nonrenewable fuse (3) and by means of external connection elements (4) the function of a holder for an element (10) that can be inserted from outside particularly in the event of a fault in a very small and compact assembly.

### PRIORITY

This application claims priority to German application no. 103 10 159.4 filed Mar. 7, 2003.

### TECHNICAL FIELD OF THE INVENTION

The present invention relates to an electrical safety device.

### DESCRIPTION OF THE RELATED ART

Electrical safety devices have been known for a long time, especially in the form of nonrenewable fuses. They are differentiated in the known manner based on their rated current range, threshold voltage range, fast or slow trip characteristics or model and fitting type as well as intended use, to name but a few differentiation criteria. All the above mentioned examples of models of electrical safety devices have in common the fact that they are increasingly difficult to integrate in circuits even in the form of chip fuses or microfuses to protect power supply and control functions due to the lack of space in each instance.

A particularly serious situation occurs within a vehicle electronics system or vehicle controller unit, which will be examined as an example below. Stringent requirements are specified here in relation to the safety of passengers and drivers. As a result the number of power functions to be protected electrically and therefore also the number of vehicle controller units will continue to increase significantly in the near future, especially in automobiles. The space available for such units is therefore strictly limited in each instance. Therefore the integration of electrical safety measures in controller units already causes major problems at present with regard to their respective location and space requirement.

Achieving adequate accessibility for the user for example for replacement operations for maintenance and repair purposes is as problematic as integration in a circuit. Such accessibility is however necessary for example in the event of a fault occurring after a safety device has tripped, for function control and/or replacing a respective safety device. It is known for example that a safety device can be assembled in a holder fitted onto a board. This allows the relatively simple and fast replacement of a respective safety device but the manufacturing costs are significantly higher. Also the space requirement of such a safety device with a holder on a circuit support increases significantly compared with the space requirement of the safety device alone.

The increasing integration density of the elements within a controller unit means that electrical safety devices alone can only be integrated with rapidly increasing difficulty. This also applies when fuse types with a very small space requirement are used, such as for example small nonrenewable fuses, in particular those known as blade fuses in the form of what are referred to as minifuses. The galvanic separation that can be brought about by such fuses in the event of a fault means that they are frequently preferred to polyswitches. In such cases, when a holder is used, the space required by a mini nonrenewable fuse on a circuit support can generally be deemed to be twice that required by the safety device alone.

### SUMMARY OF THE INVENTION

The object of the present invention is to create a maintenance-friendly safety device with a small space requirement and provide a corresponding method for its production.

The object can be achieved by an electrical safety device with a fuse element that is arranged for electrical contact purposes between two connection elements on a circuit support, wherein at least one second connection element is connected to each of the connection elements and configured as an external connection element.

At least one second external connection element can be connected to each of the connection elements in such a way that a pair of second external connection elements is configured appropriately to connect an electrical bridge of the fuse element. A pair of second external connection elements can be configured in such a way that the pair of second external connection elements is arranged in a freely accessible manner on a circuit support when the device is in a fitted position. The electrical safety device may comprise at least one fusible conductor. The connection elements can be essentially configured in pin form for contact with a printed circuit board by soldering or according to a press-fit contact method. The external connection elements can be configured as bushes, spring forks, pins, plugs or other connection means. The connection elements can be configured for contact according to an SMD method. The connection elements, the safety device and the external connection elements may be produced as a single part. The connection elements, the safety device and the connection elements can be produced together as punched/bent parts from a metal sheet. One connection element and one external connection element may form an essentially I, Y and/or H-shaped base structure and two such base constructions can be connected together, in particular by the fusible conductor. The external connection elements can be fixed in a housing. The electrical safety device can be enclosed to such a degree by its own housing that the external connecting elements and the connecting elements are only freed in a manner and to a degree required for adequate contact in each instance. For the essentially optical control of a functionality of the fuse element, the housing may comprise a type of window in one area of the fuse element and/or the housing can be made of a transparent material at least in this area. The housing can be configured as insulating to act as a guide or even counterpart of an external plug connection or an element, in particular in the area of the external connection elements.

The object can also be achieved by a method for producing an electrical safety device with a fuse element and two connection elements, comprising the steps of:

producing external connection elements together with the fusible conductor, and

configuring the connection elements to make contact with a circuit support as a punched/bent component.

The electrical safety device can be enclosed by its own housing while freeing at least the areas of the external connection elements and of the connection elements required for electrical contact, in particular by plastic injection coating or sticking together two halves of a housing made of plastic or a ceramic material, whereby in particular the fuse element is covered in a transparent manner for essentially optical control of its functionality. The electrical safety device can be configured to be inserted according to a press-fit, plug-solder or SMD assembly and contact method by automatic machine in or on a circuit support.

According to the invention an electrical safety device with a fuse element that is arranged for electrical contact purposes between two connection elements on a circuit support to make electrical contact, is characterized in that at least one second connection element is connected to each of the connection elements. These connection elements are therefore available for simplified control and maintenance measures.

A safety device according to the invention however comprises at least two further connection elements, each of which is configured as an external connection element. The term external connection element is used in the context of the present invention to refer to a connection element with which, when the safety device is fitted, a conductive contact can be established with an element that was hitherto outside the actual circuit. Such an element can therefore be connected from outside via the external connection elements.

An electrical safety device according to the invention therefore has as its basic function the function of a standard electrical fuse element that makes electrical contact in a deployment situation via two connection elements on a circuit support and thereby still has at least two free connection elements. This connection option provides an additional function over and above the basic function of an electrical fuse element.

In a significant development of the invention a pair of second external connection elements is configured appropriately to connect an electrical bridge of the fuse element. There are a plurality of exemplary applications for bridging the fuse element in this way: a measuring device can be connected here for example. A function of the fuse element can advantageously be monitored from outside by means of this measuring device. Also in the event that the fuse element has blown or tripped, a new fuse can be inserted at the external connection elements. By bridging the now defective, old fuse element, once the fault that was the basis for a previous failure and the tripping of the fuse element has been eliminated, it is then possible to restore the fuse function in a simple manner and bring the circuit back into operation. It is therefore advantageously not necessary to dismantle the now defective, old fuse element.

A pair of second external connection elements is advantageously configured so that the pair of second external connection elements is arranged in a freely accessible manner when the device is in a fitted position on a circuit support. Use of the external connection elements in an option disclosed above is then easily feasible.

An electrical safety device according to the present invention preferably comprises at least one fusible conductor as the fuse element. In a preferred application, the protection of a vehicle electronics system and/or controller circuits, galvanic separation of a subsequent electric circuit is reliably effected in this manner in the event of a fault by an external connection with voltage levels of 12 to approx. 48 volts and currents up to approx. 100 A. Series or parallel circuits of a plurality of fusible conductors can also be inserted as the actual safety element. Mechanical and/or reversible separators, for example polymer safety elements, can be inserted as electrical safety devices, as an alternative to a fusible conductor. Devices of the type mentioned can however also be inserted in addition to a fusible conductor.

The connection elements are advantageously configured essentially in pin form for contact with a printed circuit board or PCB, by soldering or according to a press-fit contact method. Alternatively the connection elements are advantageously configured for surface-oriented assembly and electrical contact according to an SMD method.

The external connection elements can be configured in some embodiments of the invention as bushes, spring forks or clips or even pins, plugs or other connection means. Identical and same-gender configuration of the connection elements is possible for each pair. In some applications however one male and one female connection contact is selected for each connection, for example simply to guarantee polarity.

In one preferred embodiment of the invention the connection elements, the safety device and the external connection elements are produced as a single part. They are preferably produced as punched/bent components, for example from a metal sheet. All the materials and/or material combinations known from the prior art in the field of nonrenewable fuse production can thereby be used.

In some embodiments of the invention one connection element and one external connection element together form an essentially I, Y or H-shaped structure, as a function of the selected connection structure. Two such structures are advantageously connected together by means of the fusible conductor. Exemplary embodiments that have specific manufacturing advantages are disclosed for this purpose with reference to the drawing.

In one embodiment of the invention the external connection elements of the safety device are fixed in a housing. This protects the electrical safety device against mechanical overload and also against the impact of an ambient atmosphere with moisture and/or contamination loading, etc. This applies in particular to the area of a fusible conductor.

However the electrical safety device is advantageously enclosed to such a degree by its own housing that the connection elements and the external connection elements are only freed in a manner and to a degree required for adequate contact in each instance. Both types of connection element are therefore fixed in a housing. A fusible conductor can also be enclosed. Plastics in the form of interlocking clips and for example plastic injection coatings in the specified area are options for such a housing. Ceramic housings can also be used for this purpose.

In one development of the invention a hollow space is provided in an area around the safety element in a housing of the type described above. Such a hollow space can be used in a manner known to the person skilled in the art, e.g. to influence a trip characteristic and/or cutout response of the fusible conductor, for example by coating and/or filling with a porous and temperature-resistant material. The use of quartz sand or special substances that eliminate switch arcs are known for this purpose from the field of tubular fuses for example.

The housing can in particular be configured in the area of the external connection elements as an insulating guide or even as the counterpart of an external plug connection. In this way the safety device can advantageously be configured by the housing as a polarized arrangement for the supply of electricity to a subsequently connected electrical circuit.

### BRIEF DESCRIPTION OF THE DRAWINGS

Further embodiments and advantages of a device according to the invention are disclosed below based on exemplary embodiments with reference to the drawings, in which:

FIGS. 1a and 1b: show a first embodiment of an electrical safety device in a fitted position in a side sectional view;

FIG. 2: shows a sketch of a punched/bent form of a second embodiment of an electrical safety device viewed from the top;

FIG. 3: shows a three-dimensional view of a third embodiment;

FIG. 4: shows a three-dimensional view of a fourth embodiment and

FIGS. 5a and 5b: show two sectional diagrams of the embodiment in FIG. 4 in a fitted position.

### DETAILED DESCRIPTION OF THE PREFERRED EMBODIMENTS

An electrical safety device 1 comprises two connection elements 2, that are connected to each other via a fusible conductor 3. Each connection element 2 is connected via an external connection element 4 to a base structure 5.

The connection elements 2 essentially correspond in dimensions and sectional form to their known contact pins. Such contact pins are inserted according to the prior art by pressing according to a press-fit contact method or by soldering in a circuit support 6. An electric circuit (not shown in any further detail) is arranged here on a printed board 6. The connection elements 2 are inserted into recesses 7 in the board 6 and then each brought into contact by tin-lead solder 8 with a respective copper conductor 9. The thickness of a conductor 9 can be from approx. 18 to around 800 μm.

One length 1 of the connection elements 2 is selected so that the electrical safety device 1 can also be gripped and/or held at the connection elements 2 by an automatic assembly machine for the computer-controlled assembly of a board 6. Press-fit contacts also can be executed in addition to electrical and mechanical connections according to a wave, reflow or laser soldering method.

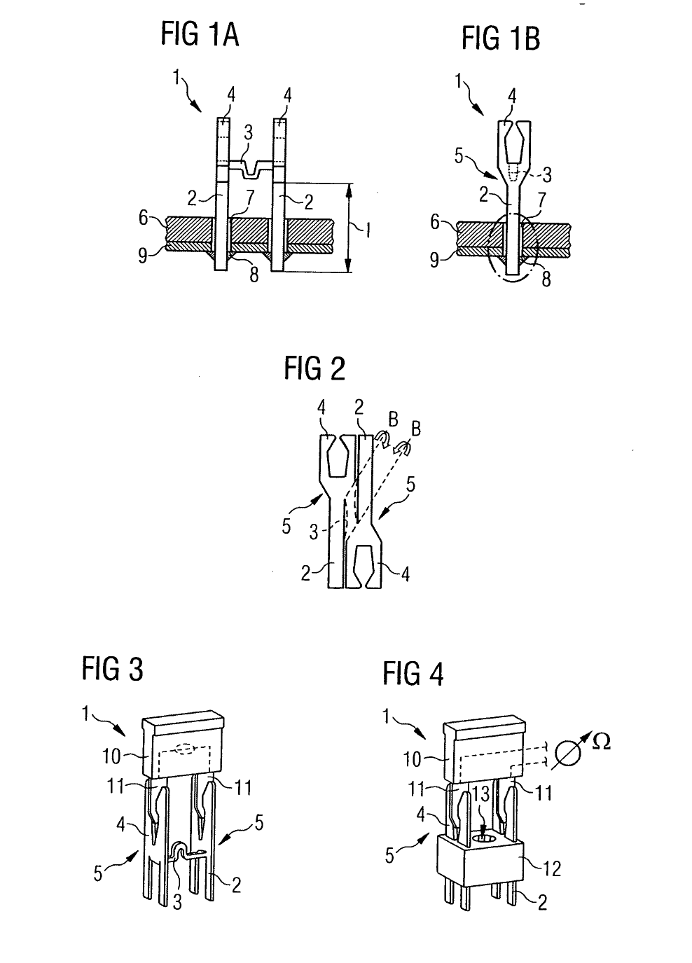

The external connection elements 4 are produced as elastic forks as outlined in FIG. 1b. The fusible conductor 3 of the embodiment in FIGS. 1a and 1b is formed by free-punching between tines of the elastic forks of the external connection elements 4. During the course of a punching/bending method the fusible conductor 3 has taken on a tapered shape (only shown in outline) by means of which for example adjustment can be made to a rated current at a predefined rated voltage, as generally known to the person skilled in the art. The fusible conductor 3 has also taken on an essentially U-shaped external form to adjust its longitudinal extension to a respective grid dimension.

An alternative punched form is outlined in a top view in FIG. 2. Here too a connection element 2 forms an essentially Y-shaped base structure 5 with an external connection element 4. Two similar base structures 5 are arranged in a point-symmetrical position in respect of each other. They are connected together as a single part by the fusible conductor 3. Here the fusible conductor 3 connects the external connection elements 4 on the outside. During the course of the punching/bending process the device 1 is shaped approximately into the form shown in FIG. 1a by bending along the bending line B in the direction of the arrows marked. Tapering in the area of the fusible conductor 3 can be achieved by punching during the course of this method or it can be carried out subsequently using known measures as known to the person skilled in the art.

According to FIG. 2 a further very compact punched form results in each case, which can be continued in any manner to the right and left of the diagram in FIG. 2 with very small punching residues. This embodiment therefore supports the processing of broad strip in a particular manner. Similarly even with a mirror-symmetrical arrangement of the Y-shaped base structures 5, further options (not shown here) also result, with which two base structures 5 can be connected together as a single piece by the fusible conductor 3. Also essentially I- or H-shaped base structures 5 can be inserted and formed in the same way using other forms of connections 2, 4.

FIG. 3 uses the example of an essentially H-shaped base structure 5 to show connection elements 2 with two contact pins each. The fusible conductor 3 is shown as a punched component in each instance between the two contact pins of the connection elements 2. A bending process then follows in the production operation and this is linked to the punching operation. A pair comprising a connection element 2 and an external connection element 4 is connected as the base structure 5, i.e. again via the fusible conductor 3, to the second base structure 5. The second base structure 5 can be configured in the same way but does not have to be for adaptation to specific uses.

The arrangement in FIG. 3 also shows an option for configuring a parallel circuit of the fusible conductor 3 with an element 10 inserted from outside. The element 10 is fixed in a mechanically detachable manner to spring forks or clips of the external contacts 4 via its own countercontacts 11 and is also brought into electrical contact thus.

In the event that the fusible conductor 3 has tripped, the element 10 can be a blade fuse, as shown in FIG. 3 by a dotted line. Inserting a blade fuse as the element 10 into the clips 4 means that a subsequent circuit can be taken back into operation or isolated after elimination of an operational failure. The old and no longer operational fusible conductor element 3 is then bridged by the element 10 by means of a parallel circuit. There is therefore no need to replace the safety device 1 and in particular no need to unsolder it.

In a fourth embodiment of a device 1 according to the invention, the electrical safety device 1 is enclosed in an area around the fusible conductor element 3 by a housing 12, see FIG. 4. The areas of the connection elements 2 and the external connection elements 4 required for electrical contact are freed in a manner shown in FIG. 4 by the housing 12. In the arrangement in FIG. 4 therefore a plug of a test device can be connected in parallel as the external element 10 to the fusible conductor 3 (not shown in further detail). During the course of a throughput or resistance measurement the function or status of the fusible conductor 3 is monitored here using this test device. A blade fuse can then be inserted as the element 10 if necessary.

The fusible conductor 3 is essentially protected by the housing 12 from detrimental external ambient influences. As well as protecting against aging due to contamination and moisture the housing 12 also provides mechanical protection for the fusible conductor 3, as it relieves tensile and compressive stresses.

The housing 12 is also equipped for the essentially optical control of a functionality of the fuse element 3 with a type of window 13 in one area of the fuse element 3, as shown in FIG. 4. A fuse element 3 separated by melting can be reliably identified through a window 13 of the type outlined. Fast monitoring of function is therefore possible. Alternatively the housing 12 can also be made of a transparent material at least in this area.

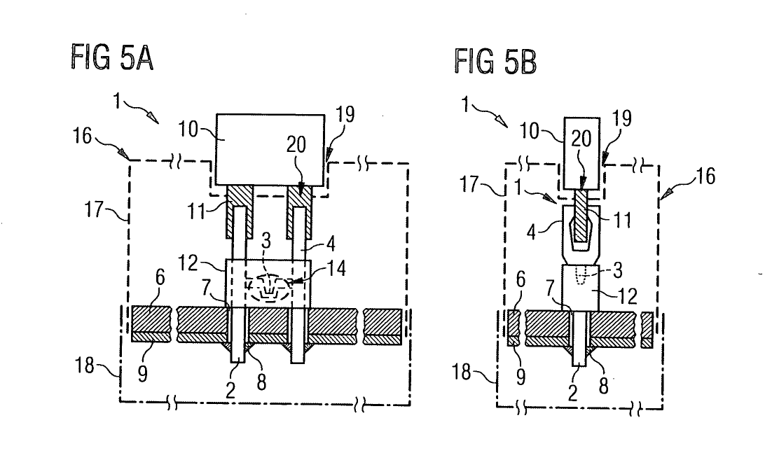

A housing 12 of the type shown in FIG. 4 provides not only a protection function for a fusible conductor 3 but also further options for functional development. The housing 12 can therefore comprise a hollow space 14 in the area of the fusible conductor 3, as shown in FIG. 5a. This hollow space 14 can absorb an arc or plasma when the fusible conductor 3 trips or cuts out. This can greatly reduce the pressure load on the housing 12 and prevent the egress of metal vapors from the housing 12 when the fusible conductor 3 cuts out.

In the present case the hollow space 14 is very simply achieved by constructing the housing 12 in the form of two interlocking clips made of plastic. A half space can easily be achieved in such a half shell and it can be produced economically as a pressed or injection-molded component. Alternatively two halves of a housing made of other electrically non-conductive and heat-resistant materials can simply be stuck together, for example two halves of a housing made of a ceramic material.

A hollow space 14 of the type disclosed allows the respective trip characteristic to be very significantly influenced by adjusting the heat balance of the fusible conductor 3. Thermal insulation will bring about more of a rapid trip characteristic. Close contact between the fusible conductor 3 and a filler however supports a rather slower trip characteristic due to the heat dissipation and cooling associated with this contact. Direct contact between the fusible conductor 3 and the material of the housing 12 can have the same effect.

Also in the present case using a special arc-eliminating casing for the fusible conductor 3 or alternatively a filling in the hollow space 14 influences the cutout response of the electrical safety device 1. These measures are however so well known to the person skilled in the art from the prior art that there is no need to go into further detail here.

According to FIG. 5a the entire circuit is enclosed with the safety device 1 in a housing 16 between an upper part of the housing 17 and a lower part of the housing 18. The upper part of the housing 17 has a cutout 19 with a recess 20 in an area above the external connection elements 4 of the safety device 1. The cutout 19 serves as a guide for inserting and making contact with the element 10 inserted from outside, whereby the recess 20 frees an area of the countercontacts 11. This ensures fast and reliable positioning of the element 10 with little weakening of the housing 16 and in particular its protective function in respect of a covered circuit.

The external connection elements 4 are at least partially enclosed in one embodiment (not shown in further graphic detail) by an essentially funnel-shaped cavity of the housing 12 in the form of a frame. This frame serves as a guide for a male or female plug-type contact connector element. It also comprises at least the height of the external connection elements 4 so that these are also protected mechanically by the guide.

In one embodiment of the invention (not shown in further graphical detail here either), the connection elements 2 are configured for assembly on a board 6 according to an SMD process. Such embodiments of connection elements are known to the person skilled in the art from the field of surface-mounted discrete resistors, capacitors, integrated circuits, jumper rails, terminal, strips, etc. with numerous developments from the prior art. Flat-pressing and bending a correspondingly dimensioned end area of the connection elements 2 vertically means that this measure can also be implemented in the known manner in a manufacturing stage of a punching/bending process based on a metal sheet.

An electrical safety device 1 is thereby disclosed above in a plurality of embodiments and modifications, said device combining the functions of a nonrenewable fuse with circuit-side contactable connection elements 2 and the function of a type of holder in a very small and compact structure. There is now only one element instead of three components, a fuse and two retaining clips. This element offers the option of inserting a blade fuse in place of the integrated fuse.

All the production methods for nonrenewable fuse elements known from the prior art can be applied without restriction to such a device. In the exemplary embodiments in the Figures the external connection element 2 together with the fusible conductor 3 and the connection elements 4 are produced as punched/bent components from a copper sheet with a silver-plated surface. Naturally, galvanically tin-plated copper sheets can also be used. Subsequent treatment and/or coating of the fusible conductor 3 is also possible.

A safety device 1 according to the invention can also be contacted according to all assembly methods known for discrete components. The safety device 1 is thereby produced on the basis of its structural principles by automatic machine and can be inserted directly in press-fit, plug-solder or SMD assembly and contact methods in a very rational manner.

It is also advantageous that the space required to achieve the safety function of a replaceable nonrenewable fuse or a nonrenewable fuse, the function of which can be substituted, is very significantly reduced by using a safety device 1 according to the invention. The safety device 1 according to the invention thereby requires less of the in any case small space on the respective circuit support 6. The space requirement of a safety device 1 according to the invention is essentially advantageously limited to that of a fusible conductor 3 with housing 12, that has to be provided in a circuit in any case.

To illustrate the advantages and various embodiments of the present invention, reference was essentially made above to deployment in the automotive field to protect various controller or electronic elements. In the automotive field rated currents up to approx. 100 A are currently protected at the 12V voltage level. Representation of this important field of application does not however specifically imply any restriction of deployment and adaptation of a safety device 1 according to the invention to this field alone. The advantages described of a safety device 1 according to the invention can also be achieved in the same way when it is used in other fields of light current electronics and energy supply of medium power level.

I claim:

1. An electrical safety device with a fuse element that is arranged for electrical contact purposes between two connection elements on a circuit support, wherein at least one second connection element is connected to each of the connection elements and configured as an external connection element.

2. The device according to claim 1, wherein at least one second external connection element is connected to each of the connection elements in such a way that a pair of second external connection elements is configured appropriately to connect an electrical bridge of the fuse element.

3. The device according to claim 1, wherein a pair of second external connection elements is configured in such a way that the pair of second external connection elements is arranged in a freely accessible manner on a circuit support when the device is in a fitted position.

4. The device according to claim 1, wherein the electrical safety device comprises at least one fusible conductor.

5. The device according to claim 1, wherein the connection elements are essentially configured in pin form for contact with a printed circuit board by soldering or according to a press-fit contact method.

6. The device according to claim 1, wherein the external connection elements are configured as bushes, spring forks, pins, plugs or other connection means.

7. The device according to claim 1, wherein the connection elements are configured for contact according to an SMD method.

8. The device according to claim 1, wherein the connection elements, the safety device and the external connection elements are produced as a single part.

9. The device according to claim 8, wherein the connection elements, the safety device and the connection elements are produced together as punched/bent parts from a metal sheet.

10. The device according to claim 1, wherein one connection element and one external connection element form an essentially I, Y and/or H-shaped base structure and two such base constructions are connected together, in particular by the fusible conductor.

11. The device according to claim 1, wherein the external connection elements are fixed in a housing.

12. The device according to claim 1, wherein the electrical safety device is enclosed to such a degree by its own housing that the external connecting elements and the connecting elements are only freed in a manner and to a degree required for adequate contact in each instance.

13. The device according to claim 12, wherein for the essentially optical control of a functionality of the fuse element, the housing comprises a type of window in one area of the fuse element and/or the housing is made of a transparent material at least in this area.

14. The device according to claim 12, wherein the housing is configured as insulating to act as a guide or even counterpart of an external plug connection or an element, in particular in the area of the external connection elements.

15. A method for producing an electrical safety device with a fuse element and two connection elements, comprising the steps of:
producing external connection elements together with the fusible conductor, and
configuring the connection elements to make contact with a circuit support as a punched/bent component.

16. The method according to the claim 15, wherein the electrical safety device is enclosed by its own housing while freeing at least the areas of the external connection elements and of the connection elements required for electrical contact, in particular by plastic injection coating or sticking together two halves of a housing made of plastic or a ceramic material, whereby in particular the fuse element is covered in a transparent manner for essentially optical control of its functionality.

17. The method according to the claim 15, wherein the electrical safety device is configured to be inserted according to a press-fit, plug-solder or SMD assembly and contact method by automatic machine in or on a circuit support.
